(19) United States
(12) Patent Application Publication
(10) Pub. No.: US 2008/0043768 A1
(43) Pub. Date: Feb. 21, 2008

(54) AFDX NETWORK SUPPORTING A PLURALITY OF SERVICE CLASSES

(75) Inventors: Juan LOPEZ, Grenoble (FR); Jerome GRIEU, Toulouse (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/776,792

(22) Filed: Jul. 12, 2007

(30) Foreign Application Priority Data
Aug. 17, 2006 (FR) 06 53382

(51) Int. Cl. H04L 12/56

(52) U.S. Cl. 370/412

(57) ABSTRACT

The invention relates to a frame switch for an AFDX network, including a plurality of input ports (615), a plurality of output ports (645), multiplexing means (630) to multiplex the frames arriving at an input port towards one or more of said output ports, control means (620) for controlling said multiplexing means. Each output port is connected by its input to at least two FIFO buffers (640, 641, 642), one of which (640) is dedicated to the deterministic flows of said network, the control means being additionally adapted to determine whether a frame belongs to a deterministic flow and, in the affirmative, to command the multiplexing means to direct said frame to one or more buffers (640) dedicated to the deterministic flows.

### TECHNICAL FIELD

The present invention relates to the field of frame switching in an AFDX network.

### PRIOR ART

Ethernet networks are the most widely known of local networks. They can operate in two distinct, mutually compatible modes: a so-called shared mode, wherein one and the same physical support is shared between the terminals, with random access and collision detection between frames, and a so-called switched mode, wherein the terminals exchange frames through virtual links, thereby guaranteeing the absence of collisions.

In a switched Ethernet network, each source or destination terminal is connected individually to a single frame switch and the switches are connected to each other by physical links. To be more precise, each switch has a plurality of ports connected to the ports of other switches or terminal couplers. A virtual link between a source terminal and a destination terminal is defined as a path orientated through the network, used by the frames from the source terminal bound for the destination terminal. In an equivalent way, a virtual link is defined as the ordered list of switches through which these frames pass. For each switch passed through, the frames are switched from the destination address, using a preset switching table. Hereinafter we shall designate as “virtual link” a level 2 end-to-end connection in a frame switching network, for example a switched Ethernet network.

It is possible to obtain a service guarantee for a virtual link. The AFDX (Avionics Full Duplex Switched Ethernet) network, developed for the needs of the Aeronautics industry, is an example of a switched Ethernet network in which it is possible to allocate a bandwidth to a virtual link. To be more precise, a minimum gap between frames as well as a maximum frame size is associated with each virtual link. Subject to these constraints being observed, a maximum frame routing time, or latency limit, is guaranteed for each virtual link.

A detailed description of the AFDX network will be found in the document entitled “AFDX protocol tutorial” available on the site www.condoreng.com and in patent application FR-A-283-2011 filed in the name of the applicant. A brief reminder of the main characteristics thereof will be given below.

As already mentioned, the AFDX network is based on a switched Ethernet network of the full-duplex type. The AFDX network is above all deterministic, in the sense that the virtual links have characteristics that are guaranteed in terms of latency limit, physical flow segregation and bandwidth. Each virtual link has as its disposal for this purpose an end-to-end reserved path, a time fragmentation into transmission gaps (known as BAG standing for Bandwidth Allocation Gap) and a maximum frame size. The frames are sent at the start of each transmission gap with a preset jitter tolerance. The data is transmitted in the form of IP packets encapsulated in Ethernet frames. Unlike conventional Ethernet switching (which uses the Ethernet address of the addressee), frame switching on an AFDX network uses a virtual link identifier included in the frame header. When a switch receives a frame at one of its input ports, it reads the virtual link identifier and determines from its switching table the output port or ports to which it is to be transmitted.

Each virtual link is mono-directional. It may only emanate from one source terminal at a time but may terminate at a number of addressees. Point-to-point (or unicast) mode virtual links serving only a single addressee are to be distinguished from multi-point (or multicast) mode virtual links serving a number thereof.

FIG. 1 shows in diagrammatic form an AFDX network including terminals T₁ to T₆ and frame switches SW₁, SW₂. It can be seen for example that the virtual link VL₃ connecting terminal T₃ to T₂ is of the point-to-point type whereas the virtual links VL₂ serving T₂ and T₃, and VL₁ serving T₃ to T₅ are of the multipoint type.

FIG. 2 shows in diagrammatic form a switch in an AFDX network. It includes a plurality L of input ports 215 and output ports 245, designated as e₁,e₂, . . . ,e_{L} and s₁,s₂, . . . ,s_{L} respectively, frame filtering means 220, multiplexing means 230 and output buffers 240 of the FIFO type connected to the output ports 245. Incident frames are analysed by the control means 220 and multiplexed by the multiplexing means 230. The control means 220 eliminate frames corresponding to an unrecognised virtual link, erroneous frames and frames leading to a violation of link characteristics. The control means 220 command the multiplexing means 230 as a function of the virtual link identifiers read in the frame headers and of the switching table. The multiplexing means direct the frames to the different output buffers 240 at a command from the control means. The output buffers transmit the frames to the physical links via a corresponding output port s₁.

Virtual link routing in an AFDX network consists in defining the switching tables of the different network switches. The routing is selected in such a way as to observe the bandwidth constraints of the different links. For a given routing solution, a check is made that the network is fully deterministic, in other words that the routing times to the different links are in fact less than the guaranteed latency limits. To do this, a calculation algorithm known as “network calculus” is generally used, a description of which may be found in the articles by René L. Cruz entitled “A calculus for network delay, Part I: network elements in isolation” and “Calculus for network delay, Part II: network analysis”, published in IEEE Transactions on Information Theory, volume 37, no. 1, January 1991, pages 114-141. This algorithm evaluates non-probabilistically, for each network element, the maximum instantaneous data rate at the output of the element in question. The traffic transmitted by a source terminal to a virtual link Lᵢ is modelled by a maximum traffic rate function, otherwise known as a flow envelope function Rᵢ(t) depending on the maximum length of the frames and on the minimum time gap separating two frames of the link. For each network element, the flow envelope at the output of this element is determined from the input flow envelope and a transfer function of said element. From the input and output flow envelopes, it is known how to limit, at upper values, the element queue size (the element work backlog) and the delay experienced by a packet passing through this element. A gradual calculation is therefore made, starting with the source terminals and progressing towards the destination terminals, of the delays experienced along the different virtual links. The latency time in relation to a virtual link is estimated from the delays experienced in the elements passed through by this link and, where appropriate, the propagation times between these elements. A check is then made as to whether the estimated latency times do actually comply with the limits it was required to guarantee for the different network links.

FIG. 3 shows a conventional flow management mechanism in an AFDX network switch.

The situation has been shown of three virtual links VL₁, VL₂, VL₃, routed through an ASDX network switch. The virtual links VL₁, VL₂, are switched from the port e₁ to the port s₃ and the virtual link VL₃ is switched from the port e₂ to the port s₃. The arrival of the frames of the virtual links VL₁, VL₂, VL₃ at the input ports e₁ and e₂ has been given as (A). It will be noted that the frames of the virtual links VL₁, VL₂ do not collide with the input of e₁ since they emanate perforce from one and the same terminal or one and the same output port of a switch. The switching table has been shown as (B): with each virtual link shown by its identifier VL_id is associated one input port and one output port for a point-to-point link, or even a number of output ports for a multipoint link. The switch reads the identifier VL_id in the frame header and deduces therefrom the output port or ports to which it is to switch it. In the present case, the three virtual links VL₁, VL₂, VL₃, are to be switched to the output port s₃.

After their integrity and their compliance with the respective characteristics of the virtual links to which they belong have been verified by the control means, frames are stored in the order of their arrival in the output buffer 240 associated with the output port s₃, as shown at (C). The frames so stored are transmitted respecting a minimum preset inter-frame gap (IFG) to the same port s₃, as shown at (D).

A major drawback of the network previously described is that the verification of determinism is tied to a routing solution. Any change of routing or any change in a link characteristic (maximum frame size, bandwidth) requires a new verification of network determinism.

In addition, the analytical determinism verification method (network calculus) is of the “worst-case” type. In other words, it checks that latency times are fully respected in the exceptional situation of all the buffers being saturated. This leads to an under-use of network resources, in terms of bandwidth and switching capacity.

The general problem at the root of the present invention lies in a more effective use of AFDX network resources while guaranteeing the determinism for some preset virtual links. To be more precise, the invention aims to offer, in addition to the deterministic flow class (guaranteed bandwidth and latency limit) conventionally offered with virtual links, lower level service classes.

### DISCLOSURE OF THE INVENTION

The present invention is defined as a frame switch for an AFDX network, including a plurality of input ports, a plurality of output ports, multiplexing means to multiplex the frames arriving at an input port towards one or more of said output ports, control means for controlling said multiplexing means. In the frame switch according to the invention, each output port is connected by its input to at least two FIFO buffers, one of which is dedicated to the deterministic flows of said network, the control means being additionally adapted to determine whether a frame belongs to a deterministic flow and, in the affirmative, to command the multiplexing means to direct said frame to one or more buffers dedicated to deterministic flows.

According to a first embodiment of the invention, each output port is connected by its input to two FIFO buffers, a first buffer being dedicated to the deterministic flows and a second buffer being dedicated to the other flows, the control means being adapted to arbitrate the transfer of frames from the first and second buffers towards said output port such that a frame from the second buffer is only transferred towards said port when the first buffer is empty.

According to a second embodiment of the invention, each output port is connected by its input to a first FIFO buffer dedicated to the deterministic flows, at least one second buffer dedicated to flows that have a statistical service quality guarantee and a third buffer dedicated to the other flows, the control means being adapted to arbitrate the transfer of frames from the first, second and third buffers towards said output port such that a frame from a second buffer is only transferred towards said port when the first buffer is empty and that a frame from the third buffer is only transferred towards said port when the first buffer and the second buffer or buffers is or are empty.

To advantage, each output port is connected to a plurality of second buffers, each second buffer being associated with a preset priority level, the control means being adapted to transfer a frame from a second buffer of given priority level towards said output port only if each second buffer of said plurality associated with a higher priority level has itself been stripped of a frame or is empty.

According to a first variant, the switch additionally includes a switching table indicating, for each virtual link to be switched, the output port or ports towards which the link is to be switched as well as the service class to which it belongs.

In this case, the control means are advantageously adapted to extract from each incident frame a virtual link identifier and to deduce therefrom based on the switching table the output port or ports towards which the frame is to be switched, and, for each of these ports the FIFO buffer in which it is to be stored.

According to a second variant, the switch includes a switching table indicating, for each virtual link to be switched, the output port or ports to which the link is to be switched, the control means being adapted to extract from each incident frame a virtual link identifier as well as a service class identifier to which it belongs and to deduce therefrom based on the switching table the output port or ports towards which the frame is to be switched, and, for each of these output ports, the FIFO buffer in which it is to be stored.

The invention is also defined as a characterised AFDX network including a plurality of such frame switches and an aircraft including an AFDX network of this kind, on board.

### BRIEF DESCRIPTION OF THE DRAWINGS

FIG. 1 shows in diagrammatic form a simple example of an AFDX network;

FIG. 2 shows in diagrammatic form the structure of a conventional AFDX network switch;

FIG. 3 shows the flow management in a conventional AFDX network switch;

FIG. 4 shows in diagrammatic form the structure of a switch according to a first embodiment of the invention;

FIG. 5 shows in diagrammatic form the flow management in a switch according to a first embodiment of the invention;

FIG. 6 shows in diagrammatic form the structure of a switch according to a second embodiment of the invention;

FIG. 7 shows the flow chart of a flow management method for a switch according to a second embodiment of the invention.

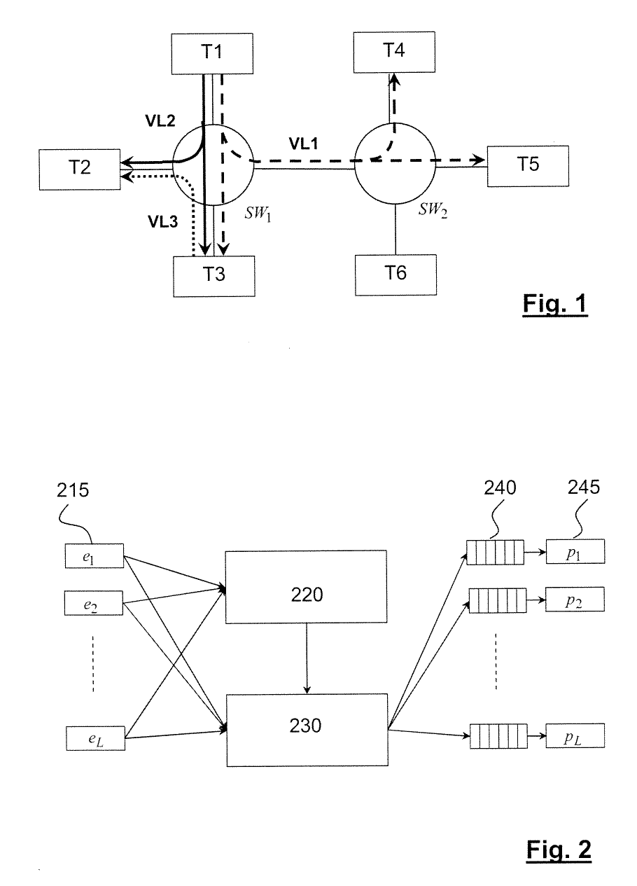

### DETAILED DESCRIPTION OF PARTICULAR EMBODIMENTS

The idea underlying the invention is to provide for each output port of an AFDX network switch, at least two queues one of which is reserved for the deterministic flows.

In a first embodiment of the switch according to the invention, two FIFO buffers are associated with each output port, one of them being dedicated to the deterministic flows. The queue of the FIFO buffer dedicated to the deterministic flows has priority relative to the other. To be more precise, the buffer relating to the non-deterministic flows is only stripped when the one dedicated to the deterministic flows is empty. In this way, given the frames of the deterministic flows, the network behaves practically as it does in the absence of any non-deterministic flow.

An AFDX network equipped with switches of this kind can support two service classes: a deterministic flow class and a class of the “best effort” type.

For the first service class, a prior check is made analytically, for example using the “network calculus” algorithm, that the routing solution for the virtual links belonging to the service class meets the latency limit and proper routing constraints in full.

On the other hand, for the second service class, neither latency limit nor probability of proper routing of the frames between the source terminal and the destination terminals is guaranteed.

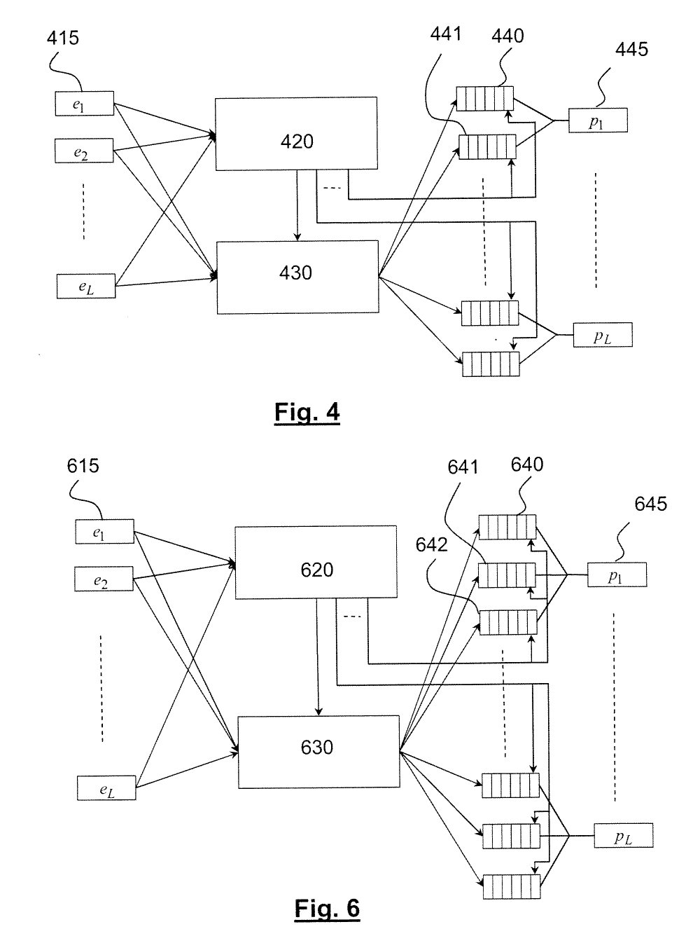

FIG. 4 shows in diagrammatic form the structure of a switch according to a first embodiment of the invention, the elements 415, 430, 445 are identical to the elements 215, 230, 245 in FIG. 2. Unlike the switch in FIG. 2 however, each output port 445 is connected to two FIFO buffers 440, 441, one of them, for example buffer 440 being dedicated to the deterministic flows and the buffer 441 to the other flows. It is important to note that the deterministic flows are thereby physically segregated from the other flows. The outputs of the buffers 440 and 441 are connected to the input of the output port 445. In this way, the control means are adapted to arbitrate the access of the buffers 440 and 441 to the output port by transmitting a stripping order to one or other buffer. It is only when the buffer 440 is empty that the control means authorise the buffer 441 to access the output port.

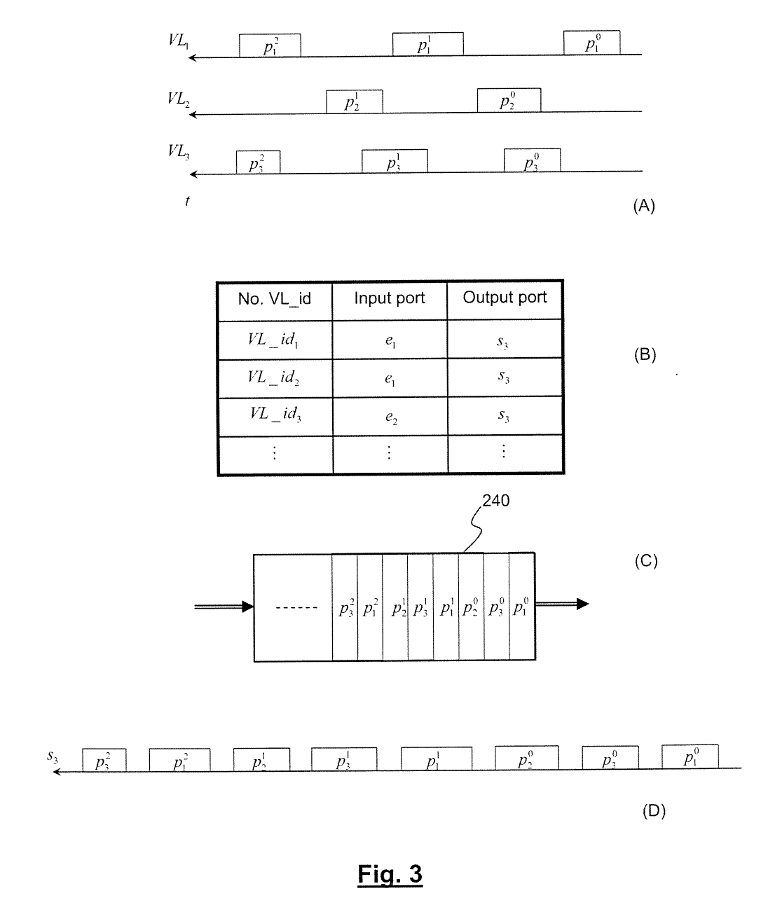

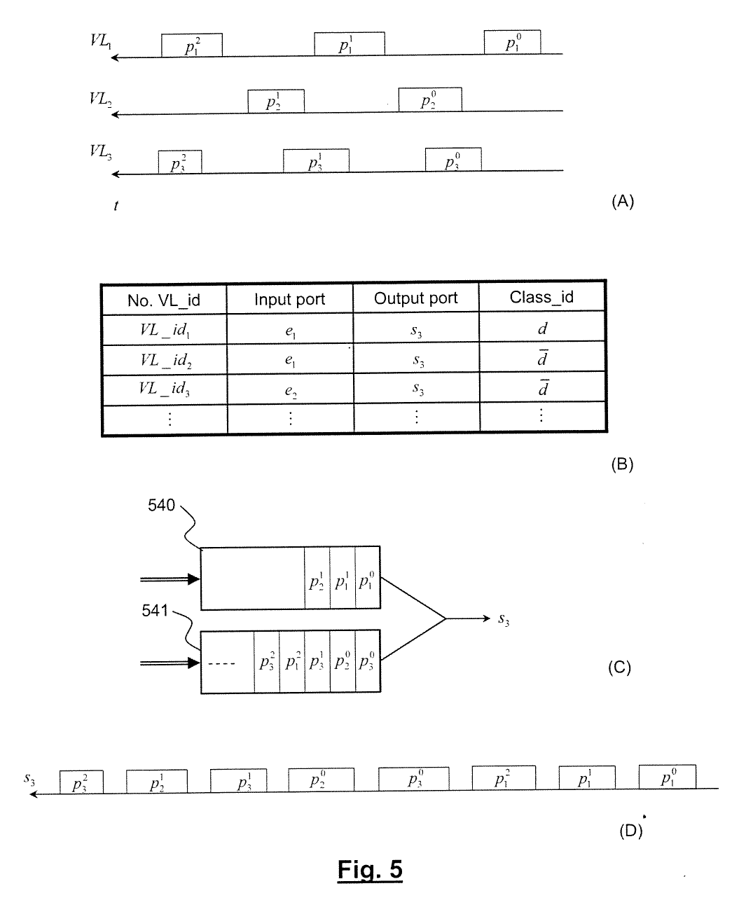

FIG. 5 shows the management flow in a switch according to the first embodiment. Further consideration is given to the case of the three virtual links in FIG. 3 with the slight difference that only the virtual link VL₁ enjoys a guarantee of determinism.

According to a first variant, the switching table, shown at (B) additionally includes, for each virtual link, an identifier of the service class associated with it, here d for a link with a determinism guarantee and d̅ for a link with no guarantee.

According to a second variant, the switching table is identical to that in FIG. 3 (B), in other words it does not include a field Class_id. In this variant, the header of each frame contains, apart from the virtual link identifier VL_id, the service class identifier Class_id associated with this link. The controller 420 reads on the fly the link identifier and the service class identifier of each incident frame and as a result commands the multiplexing means 430 to direct the frame towards the buffer 440 or the buffer 441 of the output port relative to the virtual link identified by VL_id.

It should be noted that if the virtual link is of the multi-point type, the frames may be switched to a plurality of output ports. In this case, as a function of the service class, the frame will be copied and stored in the buffers 440 or the buffers 441 associated with said output ports. The Output Port field then contains the list of output ports towards which the frame is to be switched.

At (C) it can be seen that the frames of VL₁ are arranged in the order of their arrival in the buffer 540 and the frames of VL₂, VL₃ are arranged in the order of their arrival in the buffer 541. At (D) have been shown the frames emanating from the output port s₃ as a function of time. The buffer 540 is emptied first, and then the frames contained in the buffer 541 are stripped.

In a second embodiment of the switch according to the invention, shown in FIG. 6, a plurality n>2 of FIFO buffers is provided per output port, one buffer being dedicated to the deterministic flows, one or more buffers being dedicated to the flows for which a statistical quality of service is guaranteed and one buffer being dedicated to the flows for which no guarantee is offered.

The elements 615, 630, 645 are identical to the elements 215, 230, 245 in FIG. 2 and will not be further described. Unlike the switch in FIG. 2 however, each output port 645 is connected to at least three FIFO buffers 640, 641, 642. One of them, for example the buffer 640 is dedicated to the deterministic flows. One or more buffers 641 are dedicated to the flows for which a statistical service quality is guaranteed. Lastly, a buffer 642 is dedicated to the flows with no service quality guarantee. The control means 620 are adapted to arbitrate the access of the buffers 640, 641, 642 to the output port 645 giving respective stripping orders to the aforementioned buffers.

Statistical quality of service is defined as a probability of proper routing or, in an equivalent way as a loss rate. Another potential type of statistical quality of service is that of a median bandwidth. As far as the loss rate is concerned, a frame will be lost when the output buffer in which it is to be stored has reached saturation. The loss rate may be estimated in different ways particularly by statistical calculation, by Monte Carlo type simulation or by using measurements on representative networks. In the event of frame loss, a error recovery mechanism will be provided at a higher protocol level.

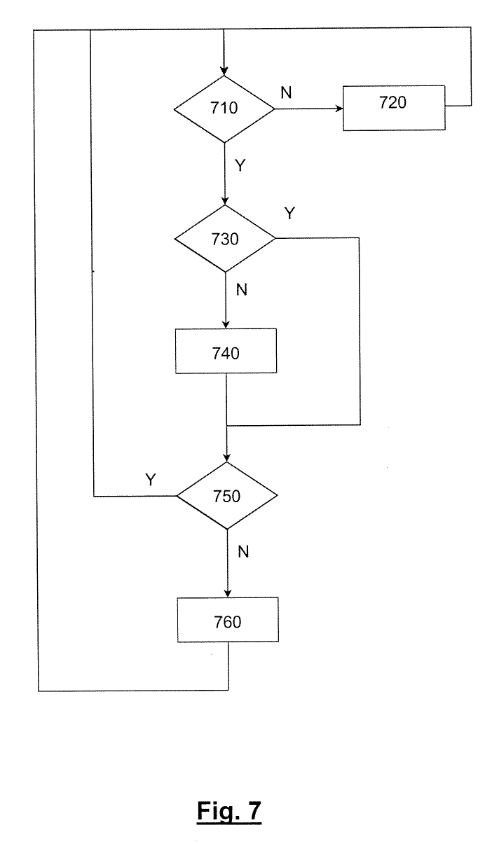

FIG. 7 shows the flow management method for the switch in FIG. 6. It is applied to the output ports in parallel, so that they are processed equitably.

A check is made at 710 as to whether the buffer 640 is empty and, in the negative, it is used at 720, in other words its oldest frame is stripped. The process is iterated until the buffer 640 is empty. The next stage is testing 730 where a check is made as to whether the or all the buffers 641 are empty. In the affirmative, the testing stage 750 is implemented. In the negative, a distinction is made between a single buffer 641 and a plurality of buffers 641. In the first case, the single non-empty buffer is served at 740. In the second case, a selection strategy explained in detail below is applied. Then go back to testing 710.

At 750, a check is made as to whether the buffer 642 is empty. In the affirmative go back to testing 710. In the negative, this buffer is used at 760 then go back to testing 710.

According to a first strategy, the buffer 641 to be used at 740 is selected as a function of a priority level assigned to each buffer: a non-empty buffer of given priority level is only used if the non-empty buffers of higher priority levels have all been used. To do this, a service flag is used for each buffer and when all the buffers 641 have either been used or are empty, the flags are re-initialised.

According to a second strategy, the buffer to be stripped is selected according to a cyclical or pseudo-random sequence, each buffer 641 having on average a probability pᵢ of being used at stage 740, with of course

$${\sum }_{i = 1}^{N} {p}_{i} = 1.$$

### The probabilities pᵢ are advantageously selected different so as to offer different statistical service quality classes.

Among these service quality classes, only the deterministic flow class allows a virtual circuit to be established between any two terminals of an AFDX network. On the other hand, the statistical service quality classes and all the more so the class with no service quality guarantee are not able to guarantee the proper routing of the frames. They do however allow the network resources left available by the deterministic flows to be used effectively.

1. Frame switch for an AFDX network, including a plurality of input ports (415, 615), a plurality of output ports (445, 645), multiplexing means (430, 630) to multiplex the frames arriving at an input port towards one or more of said output ports, control means (420, 620) for controlling said multiplexing means, characterised in that each output port is connected by its input to at least two FIFO buffers, one of which is dedicated to the deterministic flows of said network, the control means being additionally adapted to determine whether a frame belongs to a deterministic flow and, in the affirmative, to command the multiplexing means to direct said frame to one or more buffers dedicated (440, 640) to the deterministic flows.

2. Switch according to claim 1, characterised in that each output port (445) is connected by its input to two FIFO buffers (440, 441), a first buffer (440) being dedicated to the deterministic flows and a second buffer (441) being dedicated to the other flows, the control means being adapted to arbitrate the transfer of frames from the first and second buffers towards said output port such that a frame from the second buffer is only transferred towards said port when the first buffer is empty.

3. Switch according to claim 1, characterised in that each output port (645) is connected by its input to a first FIFO buffer (640) dedicated to the deterministic flows, at least one second buffer (641) dedicated to flows that have a statistical service quality guarantee and a third buffer (642) dedicated to the other flows, the control means (620) being adapted to arbitrate the transfer of frames from the first, second and third buffers towards said output port such that a frame from a second buffer is only transferred towards said port when the first buffer is empty and that a frame from the third buffer is only transferred towards said port when the first buffer and the second buffer or buffers is or are empty.

4. Switch according to claim 3, characterised in that each output port is connected to a plurality of second buffers (641), each second buffer being associated with a preset priority level, the control means being adapted to transfer a frame from a second buffer of given priority level towards said output port only if each second buffer of said plurality associated with a higher priority level has itself been stripped of a frame or is empty.

5. Switch according to any one of the previous claims, characterised in that it additionally includes a switching table indicating, for each virtual link to be switched, the output port or ports towards which the link is to be switched as well as the service class to which it belongs.

6. Switch according to claim 5, characterised in that the control means are adapted to extract from each incident frame a virtual link identifier and to deduce therefrom based on the switching table the output port or ports towards which the frame is to be switched, and, for each of these output ports, the FIFO buffer in which it is to be stored.

7. Switch according to any one of claims 1 to 4, characterised in that it includes a switching table indicating, for each virtual link to be switched, the output port or ports to which the link is to be switched, the control means being adapted to extract from each incident frame a virtual link identifier as well as a service class identifier to which it belongs and to deduce therefrom based on the switching table the output port or ports towards which the frame is to be switched, and, for each of these output ports, the FIFO buffer in which it is to be stored.

8. AFDX network characterised in that it includes a plurality of frame switches according to one of the previous claims.

9. Aircraft characterised in that it includes an AFDX network according to claim 8.
